(19) United States
(12) Patent Application Publication
(10) Pub. No.: US 2026/0054934 A1
(43) Pub. Date: Feb. 26, 2026

(54) OMNIDIRECTIONAL WHEEL AND CONVEYING INSTALLATION

(71) Applicant: Paul WORMS, Berlin (DE)

(72) Inventor: Paul WORMS, Berlin (DE)

(21) Appl. No.: 19/104,899

(22) PCT Filed: Aug. 16, 2023
(86) PCT No.: PCT/EP2023/072496

§ 371 Date: Feb. 19, 2025

(30) Foreign Application Priority Data
Aug. 31, 2022 (DE) 10 2022 121 967.4

(51) Int. Cl. B65G 13/06; B65G 39/04

(52) U.S. Cl. CPC B65G 13/06; B65G 39/04; B65G 2207/34

(57) ABSTRACT

The invention relates to an omnidirectional wheel (10) with a center shaft that extends along a center shaft rotational axis (A₁₂) and a bearing drum (24) that can be rotated about a bearing drum rotational axis, at least three first-set rollers that are mounted on the bearing drum (24) such that they can be rotated about a first-set roller rotational axis (A_{14.i}), which extends transversely to the center shaft rotational axis (A₁₂), are arranged around the center shaft (12) at an angular distance from each other and each have a helical-toothed first-set roller outer thread (18), at least three second-set rollers (16.i), which are mounted on the bearing drum (24) such that they can be rotated about a respective second-set roller rotational axis, which extends transversely to the center shaft rotational axis (A₁₂), are arranged around the center shaft (12) at an angular distance from each other, in particular with a respective angular offset (φ) to the first-set rollers (14.i) and each have a helical-toothed second-set roller outer thread (20), wherein the rollers at least partially protrude above the bearing drum (24) and wherein the omnidirectional wheel (10) is configured in such a way that a rotation of the center shaft (12) about the center shaft rotational axis (A₁₂) relative to the bearing drum (24) effects a rotational movement of the rollers about their respective rotational axis in the same direction of rotation in each case, wherein the center shaft (12) comprises a drive worm (22) that engages with the outer threads.

The invention relates to an omnidirectional wheel and a conveying installation with such an omnidirectional wheel.

Omnidirectional wheels are used to generate a speed that can be preset without having to swivel the omnidirectional wheel. For example, omnidirectional wheels are used in conveying installations in order to convey and/or rotate general cargo, particularly packages, in a preset direction.

DE 20 2016 006 843 U1 discloses an omnidirectional wheel in which spherical rollers have on outer thread in the area of maximum diameter, said thread being driven in each case by an assigned driving gearwheel. The driving gearwheel itself is driven by a worm shaft.

U.S. Pat. No. 8,752,696 B2 describes an omnidirectional wheel drive in which the spherical rollers have a helical thread in the area of maximum diameter, said thread being driven with a gearwheel with helical teeth.

The invention aims to propose an improved omnidirectional wheel.

The invention solves the problem by way of an omnidirectional wheel with the features of claim 1. It is advantageous, but not essential, for the first-set rollers and/or the second-set rollers to be at the same distance from the center shaft.

The advantage of the invention is that such an omnidirectional wheel can usually be made to be especially compact. Due to the fact that the rollers are directly driven by the drive worm, there is no need for additional installation space between center shaft and rollers.

A further advantage is that the omnidirectional wheel is often comparatively efficient. In other words, the loss between the drive power and the power that can be transmitted via the rollers is small. This is due to the convenient combination of worm drive and helical toothing.

A further advantage is the high contact surface between the rollers and the goods to be conveyed. In particular, the area of the rollers in which the outer thread is arranged can contact and move the goods to be conveyed.

It is particularly beneficial if the first-set rollers and the second-set rollers engage directly with the drive worm. In other words, the torque is directly transmitted to the first and second-set rollers by the drive worm without an intermediate transmission unit.

Within the scope of the present description, the feature that the rollers at least partially protrude above the bearing drum is understood in particular to mean that the rollers can come into contact with an external object, such as a package.

The feature that the rotational axis of the first-set rollers extends transversely to the rotational axis of the center shaft is understood in particular to mean that an angular offset between the rotational axis of the first-set rollers and the rotational axis of the center shaft is at least 42°, especially at least 45°, and at most 90°.

According to one preferred embodiment, the angular offset is 85° to 90°. According to a further preferred embodiment, the angular offset is 45°±3°.

Preferably, the first-set rollers and the second-set rollers are arranged at equidistant angles. If there are precisely three first-set rollers, as intended according to one preferred embodiment, they are each arranged at an offset angle of 120° to each other. If there are precisely four first-set rollers, as intended according to one preferred embodiment, they are arranged at the offset angle of 90° to each other.

Preferably, the first-set rollers are arranged at the same axial first-set height in relation to the center shaft. In other words, the projections of the centers of mass of the first-set rollers lie on top of each other on the rotational axis of the center shaft or at least so close together that, to a good approximation, they can be considered to be on top of each other. Alternatively, however, the first-set rollers can also be arranged at different axial heights. The second-set rollers are preferably arranged at the same axial second-set height in relation to the center shaft, wherein the first-set height is different to the second-set height.

It is favorable if the second-set rollers are arranged at an angular offset relative to the first-set rollers that corresponds to half the offset angle.

According to one preferred embodiment, the outer thread has a helix angle of at least 3°, particularly at least 6°. Alternatively or additionally, the helix angle is at most 65°. In particular, the drive worm has a high-helix screw.

Preferably, the first-set rollers and the second-set rollers have a barrel-shaped outer contour, at least in the area of the respective outer thread. The outer thread is preferably formed by depressions sunk into the outer contour. This is understood to mean that without the depressions, the outer contour would be strictly convex in the circumferential direction and the longitudinal direction.

It is favorable if the tooth base of the outer thread is concavely curved. This results in an especially short area in which the outer thread is present whilst still enabling an effective transmission of the torque to the outer thread by the drive worm.

In particular, it is beneficial if the tooth base is more starkly curved than an outer contour of the first-set rollers in the area of the outer thread in relation to the direction of the corresponding rotational axis of the rollers.

The tooth base preferably has a tooth base radius of curvature and the drive worm has a drive worm outer radius. The quotient of the tooth base radius of curvature as numerator and the drive worm outer radius as denominator is preferably between 2 and 0.5. This enables a smaller installation space whilst still ensuring a sufficiently large torque to be transmitted to the rollers by the drive worm.

According to one preferred embodiment, at least one roller, preferably a plurality of rollers, preferably all rollers, has/have (a) a first material area, referred to as a toothing area, in which the outer thread is configured, and (b) a second material area, referred to as a conveying area, which differs from the first material area in its hardness, its static friction coefficient against cardboard and/or plastic (for example acrylonitrile butadiene styrene). In other words, the rollers in the conveying area are tribologically optimized in such a way that the rollers have a good grip on cardboard and/or plastic containers. Preferably, the material in the toothing area is harder than the material in the roller shaft area.

The conveying area is preferably the area in which the rollers come into contact with the conveyed goods, i.e. the objects to be conveyed, during operation of the omnidirectional wheel, especially the conveying installation.

Preferably, at least one roller, particularly a plurality of rollers, preferably all rollers, are additively manufactured. According to one preferred embodiment, at least one roller, particularly a plurality of rollers, preferably all rollers, are coated and/or produced by injection molding. For example, the omnidirectional wheel may be made of rubber or silicone in the conveying area or comprise a rubber or silicone object.

The bearing drum preferably has a cylindrical outer contour with a bearing drum curvature in the circumferential direction. In the longitudinal direction, i.e. in relation to a cut in the direction of the longitudinal axis, the rollers have a wheel curvature that preferably corresponds to the bearing drum curvature, i.e. deviates from this, in particular, by a maximum of 20%.

It is favorable if the one roller outer contour of the rollers is designed in such a way that the wheel outer contours of the first-set rollers extend along a joint circle. If the omnidirectional wheel is rotated about its center shaft rotational axis, it results in especially smooth running.

Preferably, a plurality of the first-set rollers is structurally identical; in particular, all first-set rollers are structurally identical. In addition, a plurality of the second-set rollers, in particular all second-set rollers, is preferably structurally identical to each other and the first-set rollers. In particular, all rollers are structurally identical.

Preferably, at least a majority of the rollers, in particular all rollers, is mounted by means of a cage on the bearing drum. A cage refers to a device by means of which the rollers are mounted and which can be separated from the bearing drum. The cage itself is attached to the bearing drum. This allows a simple mounting of the rollers on the bearing drum from the axial outside (in relation to the bearing drum). In addition, the gap between the bearing drum and the roller is generally smaller than it would be if the roller were attached to the bearing drum from the axial outside without a cage.

Preferably, the cage is connected to the bearing drum via a snap-on connection, especially in a reversible manner. A snap-on connection refers to a connection that results in a form-fitting connection, during the formation of which one part, preferably the cage in the present case, is elastically deformed before the form-fitting connection is made. The cage preferably has a snap-in hook.

The snap-on connection is preferably reversible, i.e. detachable. This means that the cage can be repeatedly detached from and attached to the bearing drum without damaging the cage or the bearing drum.

Preferably, the cage contains a bearing for the corresponding roller. In particular, the roller is mounted entirely on the cage. This means that the bearing seat for the roller is configured entirely on the cage.

The cage is preferably made of plastic. For example, the cage can be designed as an injection-molded component. It is advantageous if the cage is made of reinforced plastic, especially fiber-reinforced plastic. Alternatively or additionally, the cage may have an insert component made, for example, of metal. This reinforces the cage. Alternatively, the cage may be a metal injection-molded component.

The cage preferably has a bearing bush for supporting the roller. For example, the roller is rotatably mounted by means of a shaft, particularly one made of metal. Said shaft is accommodated in the bearing bush. It is advantageous, but not essential, for the roller to rotate about the shaft. In other words, the shaft stays still or rotates more slowly than the roller. This minimizes the amount of bearing bush wear. Preferably, precisely one roller is mounted on each cage and/or each roller is mounted on precisely one cage.

According to one embodiment, at least a majority of the rollers is mounted on the bearing drum by means of a frame. In combination with the bearing drum, the frame forms a bearing seat for the roller. Preferably, the frame is connected to the bearing drum via a snap-on connection, especially in a reversible manner. A frame is different to a cage in that the cage supports the roller entirely, i.e. the bearing seat is entirely configured on the cage. Conversely, the bearing seat is only partially configured on the frame, with the rest of the bearing seat being on the bearing drum. The frame preferably has the other features mentioned above for the cage.

It is beneficial if a slot between the roller on the one hand and the cage or frame on the other is at most 1 mm. If the slot does not have a constant width, the average width of the slot is at most 1 mm. This reduces the likelihood of an object to be conveyed being drawn into the slot.

It is favorable if, at least for a majority of the rollers, a tooth base of the roller extends along a strip that extends in a spiral on the lateral surface of a cylinder. In particular, a plurality of the tooth bases, in particular all tooth bases, extends in each case along one strip that extends in a spiral on the lateral surface of a cylinder. In particular, the tooth bases are twisted. In particular, the strip, especially each strip, extends helically. Such a roller is particularly easy to produce.

The invention also includes an omnidirectional shaft and an omnidirectional matrix, each of which comprises all components of an omnidirectional wheel according to the invention and, in addition, at least a third set of rollers which (i) are supported on the bearing drum such that they can be rotated about a respective rotational axis, which extends transversely to the center shaft rotational axis, (ii) are arranged at an angular distance from each other around the center shaft and (iii) each have an outer thread and engage with the drive worm.

In the omnidirectional shaft, the sets of rollers are arranged along the center shaft rotational axis. In the omnidirectional matrix, the omnidirectional wheels are arranged in a regular pattern. A regular pattern is a pattern with translational symmetry.

With such an omnidirectional shaft, large objects lying on a number of rollers at the same time can be moved in a direction that can be preset.

Preferably, the omnidirectional wheel or the omnidirectional shaft has (a) a bearing drum drive for rotating the bearing drum around the center shaft rotational axis, (b) a center shaft drive for rotating the center shaft and (c) a control unit that is configured to automatically control the bearing drum drive and the center shaft drive. The higher the rotational frequency of the bearing drum drive and the center shaft drive, the faster an object in contact with the rollers will be conveyed. The greater the rotational frequency difference between the bearing drum drive and the center shaft drive, the more the object will be conveyed in the axial direction in relation to the center shaft rotational axis.

The control unit has a digital memory or is in contact with one in which the relevant rotational frequency of the bearing drum drive and the center shaft drive is stored for each speed. For example, it may be stored as a formula or in the form of a table. The speed is a vector and has a magnitude and a direction.

It is favorable if (a) the bearing drum has one bearing web for each first-set roller, (b) each bearing web has two bearing points for one roller each, (c) the bearing webs are each connected to two connecting webs in the circumferential direction, and (d) the connecting webs have a radial and/or concave depression in the circumferential direction between two bearing points. The connecting webs are preferably identically shaped. The depression increases the stability of the bearing drum at the same weight.

It is especially favorable if both the first-set rollers and the second-set rollers are mounted on the bearing drum.

In the following, the invention will be explained in more detail with the aid of the accompanying drawings. They show:

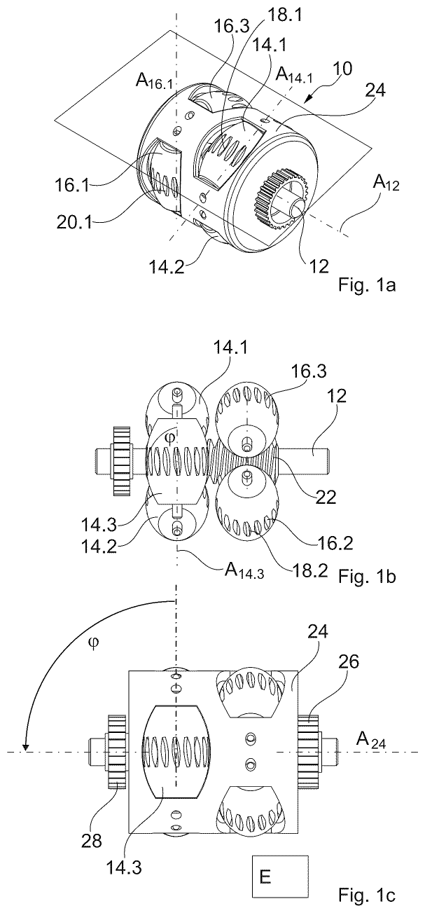

FIG. 1 in partial FIG. 1a, an omnidirectional wheel according to the invention in a perspective view,
in partial FIG. 1b, the omnidirectional wheel according to FIG. 1a without the bearing drum, and
in partial FIG. 1c, a perpendicular view of the center shaft rotational axis,

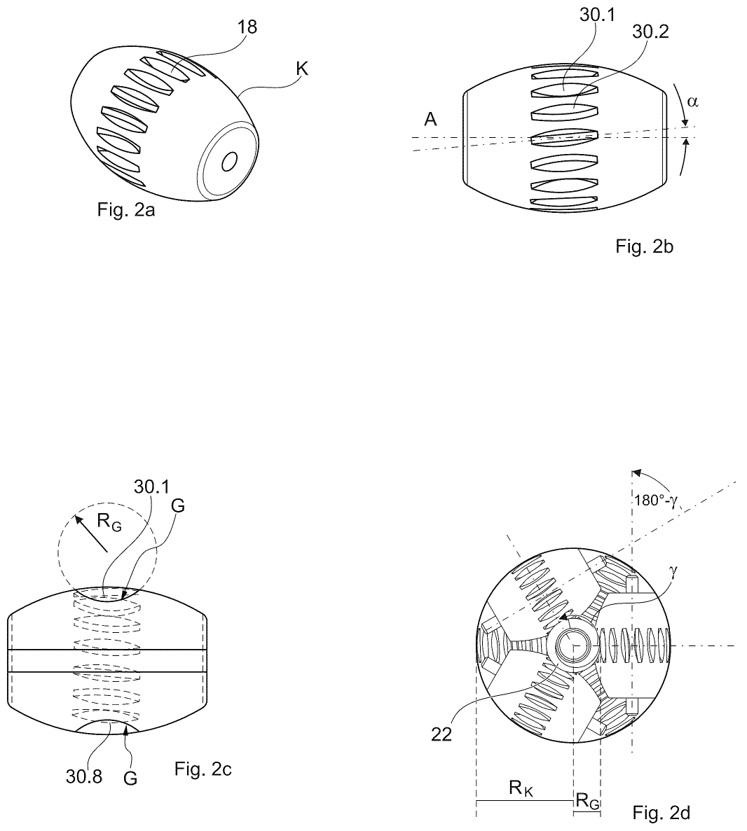

FIG. 2 in partial FIG. 2a, a first-set roller in a perspective view,
in partial FIG. 2b, the first-set roller in a view perpendicular to the roller rotational axis or axial to the center shaft, and
in partial FIG. 2c, the first-set roller in a sectional view,
in partial FIG. 2d, the first-set rollers and the second-set rollers in a top view in the axial direction,

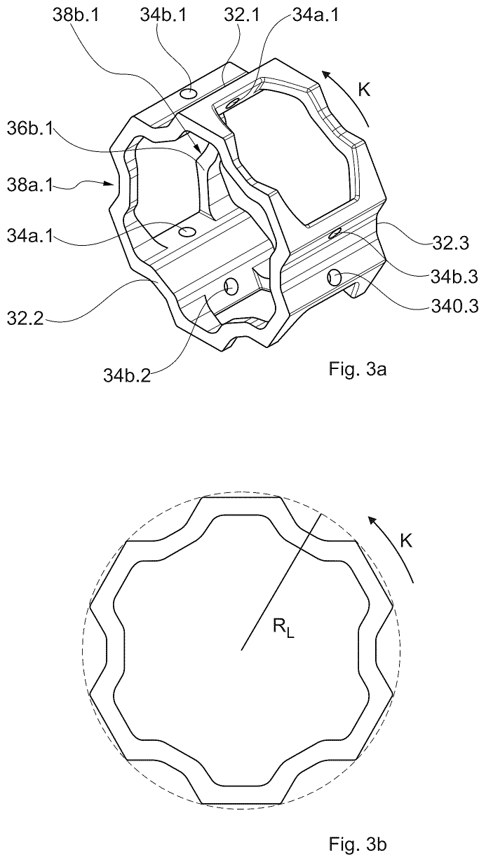

FIG. 3 in partial FIG. 3a, a bearing drum in a perspective view and
in partial FIG. 3b in a cross-sectional view.

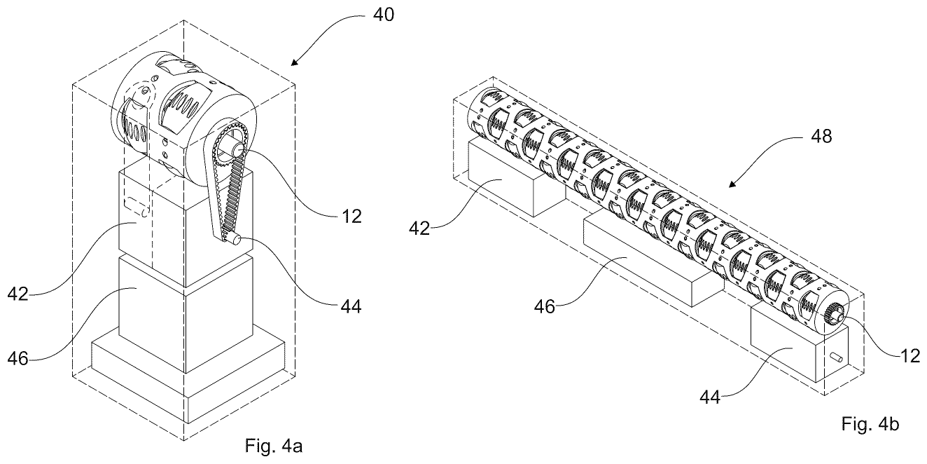

FIG. 4 in partial FIG. 4a, an omnidirectional wheel unit according to the invention with a bearing drum drive and a center shaft drive, and in partial FIG. 4b, an omnidirectional shaft and

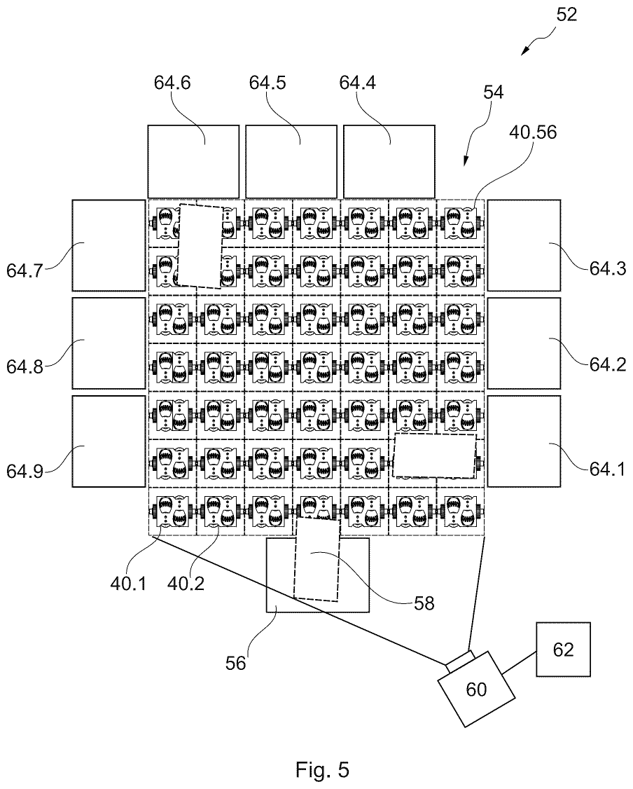

FIG. 5 an omnidirectional matrix according to the invention composed of a plurality of omnidirectional wheel units.

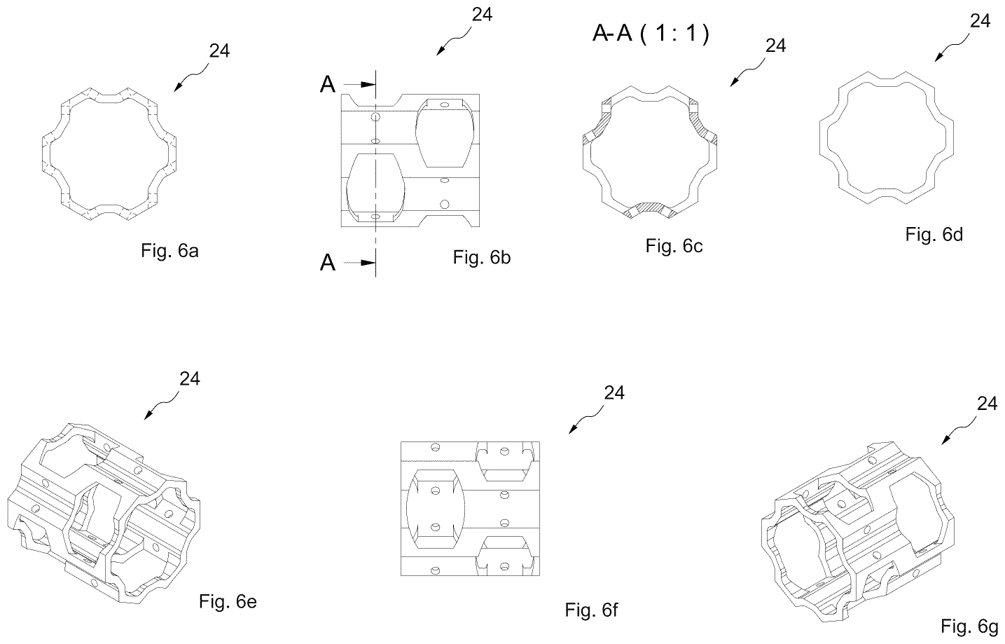

FIG. 6 in the partial FIGS. 6a-6g, a bearing drum for a two-rowed omnidirectional wheel,

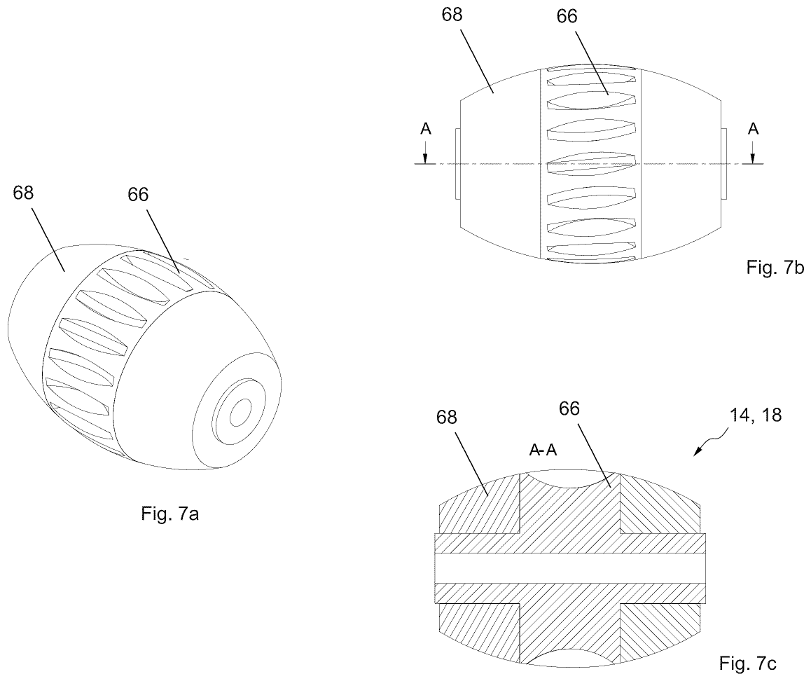

FIG. 7 in the partial FIGS. 7a-7c, a (first-set or second-set) roller of an omnidirectional wheel according to the invention,

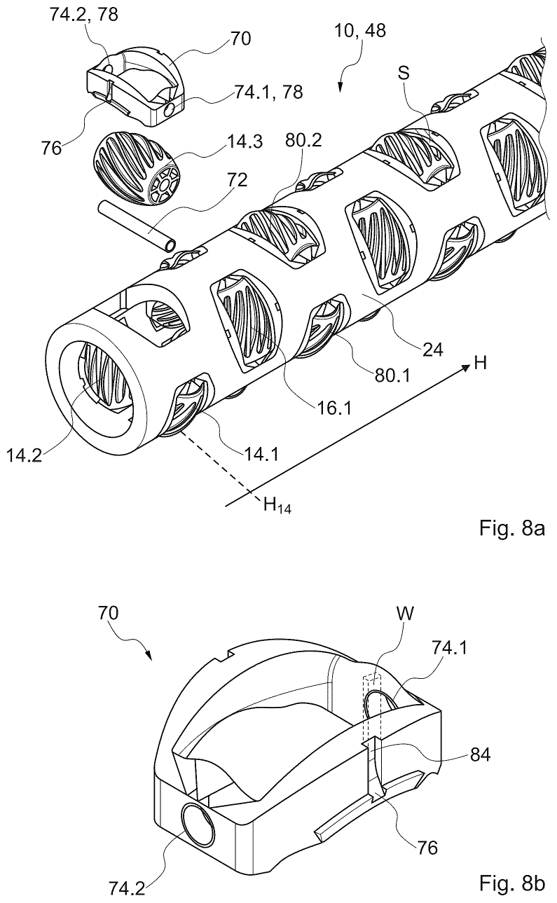

FIG. 8 in partial FIG. 8a, an omnidirectional wheel according to the invention and an omnidirectional shaft according to the invention with rollers attached by means of a cage, and
in partial FIG. 8b, a perspective view of the cage,

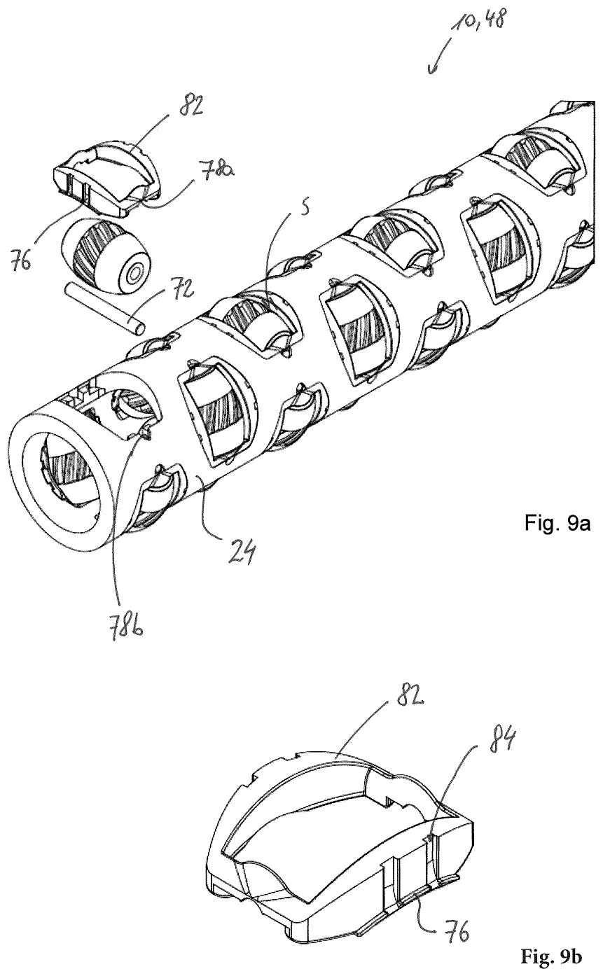

FIG. 9 in partial FIG. 9a, an omnidirectional wheel according to the invention and an omnidirectional shaft according to the invention with rollers attached by means of a frame, and
in partial FIG. 9b, a perspective view of the frame and

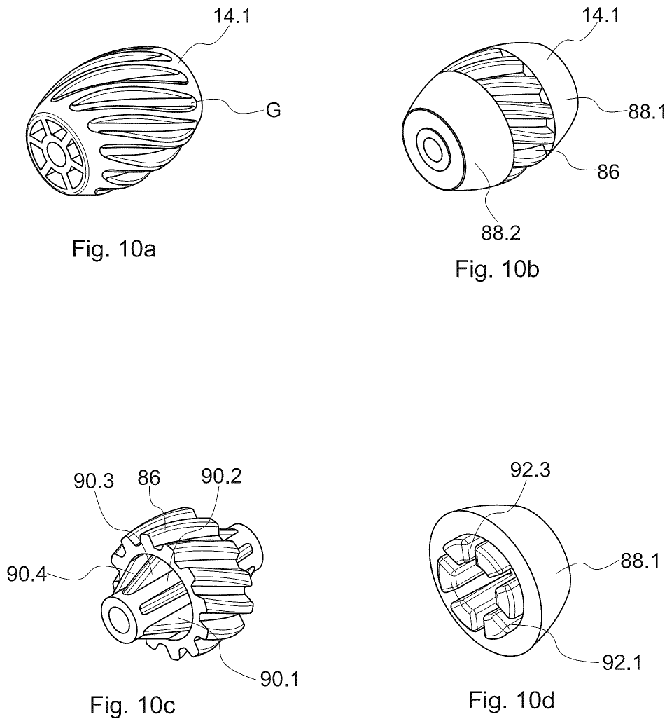

FIG. 10 in the partial FIGS. 10a-10d, a (first-set or second-set) roller of an omnidirectional wheel according to the invention,

FIG. 1 depicts an omnidirectional wheel 10 according to the invention with a center shaft 12 that extends along a center shaft rotational axis A₁₂. The omnidirectional wheel 10 has three first-set rollers 14.i (i=1, 2, 3) that are mounted such that they can be rotated about a respective first-set roller rotational axis A_{14.i}. An angular offset q is formed between the center shaft rotational axis and the respective first-set rotational axis, wherein said offset in the present case can be, but does not have to be, φ=90°. In particular, the angular offset can be smaller than 90° and preferably lies in the interval φ=∈[43°, 90°].

FIG. 2d shows that the first-set rollers 14.i are arranged at an offset angle γ around the center shaft 12. In the present case γ=120°.

FIG. 1a illustrates that the omnidirectional wheel 10 also has three second-set rollers 16.i, each of which is mounted such that it can be rotated about a second-set roller rotational axis A_{16.i} (in FIG. 1a: A_{16.1}). The second-set rollers 16.i are arranged at the same offset angle γ around the center shaft 12.

The first-set rollers 14.i each have a first-set roller outer thread 18.i (in FIG. 1a: 18.1) and the second-set rollers 16.i each have a second-set roller outer thread 20.i (in FIG. 1a: 20.1). The center shaft 12 has a drive worm 22 that engages with both the first-set roller outer threads 18.i and the second-set roller outer threads 20.i, thereby driving them.

FIG. 1 shows that the first-set rollers 14.i and the second-set rollers 16.i are attached to a bearing drum 24. The bearing drum 24 has a bearing drum rotational axis A₂₄ about which the bearing drum 24 is rotatably mounted. In order to rotate the bearing drum 24, it may comprise a thread section 26. The center shaft 12 can be rotated relative to the bearing drum 24 by means of a second thread section 28. This enables a speed \vec{v} to be set, which is determined in relation to a reference plane E. The reference place E extends parallel to the center shaft rotational axis A₁₂ and at a distance from the center shaft rotational axis A₁₂, so that one of the rollers 14.i, 16.i touches the reference plane E. To ensure that such a reference plane E exists, the rollers 14.i, 16.i partially protrude above the bearing drum 24.

FIG. 2a shows that the first-set rollers 14.i and the second-set rollers 16.i have a convex outer contour K.

FIG. 2b shows that the first-set roller outer thread 18 is formed by depressions 30.j that are sunk into the outer contour K. The number J of depressions is preferably between 5 and 50.

There is helix angle α between the respective roller rotational axis A and the direction of the tooth base. Said angle is, for example, α=5°.

FIG. 2c shows the depressions 30.1, 30.8. A tooth base G is concavely curved and has a tooth base radius of curvature R_{G}. The tooth base radius of curvature R_{G} is the radius of the circle that optimally approximates the tooth base G.

FIG. 2d demonstrates that the outer contour K of the rollers 14.i, 16.i has an outer contour radius of curvature R_{K}. A ratio V=R_{G}/R_{K} is preferably between 0.1 and 0.5. The drive worm 22 has a drive worm outer radius R_{A}. A quotient Q=R_{G}/R_{A} is preferably between 2 and 0.5.

FIG. 3 shows that the bearing drum 24 has a bearing drum radius of curvature R_{L} in the circumferential direction, said radius corresponding to the radius of the circumference. The circumference is the circle with a minimum radius that surrounds the bearing drum. The bearing drum radius of curvature R_{L} corresponds to the outer contour radius of curvature R_{K}, which means that both should be as similar to each other as possible, but may deviate from one another by at most 20%, for example, in particular by at most 10%.

FIG. 3a shows that the bearing drum 24 comprises a bearing web 32.i for each first-set roller 14.i. Each bearing web 32.i has two bearing points 34a.i, 34b.i, each of which is for one roller. In this way, the first first-set roller 14.i is supported at the bearing points 34a.1 and 34b.1.

Each bearing web 32.i is connected to the adjacent bearing web 32. (i+1) mod3 by two connecting webs 36a.i, 36b.i. (mod refers to the modulo function, where mod(3+1)=1). As such, the bearing web 32.1 is connected to the bearing web 32.2 by means of the connecting webs 36a.1, 36b.1. The connecting webs 36a.i, 36b.i may each have a radial depression 38a.i, 38b.i between two bearing webs in the circumferential direction U. The connecting webs are preferably identically shaped. The depressions 38a.i, 38b.i increase the stability of the bearing drum 24 at the same weight.

FIG. 4a depicts an omnidirectional wheel unit 40 according to the invention which, in addition to the features according to claim 1, comprises a bearing drum drive 44 for driving the bearing drum 24 about the center shaft rotational axis A₁₂ and a center shaft drive 42 for driving the center shaft 12. The omnidirectional wheel unit 40 may also comprise a control unit 46 for controlling the bearing drum drive 42 and the center shaft drive 44.

FIG. 4b depicts an omnidirectional shaft 48 comprising the center shaft 12 as well as sets 50.m of rollers. The first set 50.1 of rollers encompasses the first-set rollers 14.i, the second set 50.2 of rollers encompasses the second-set rollers 16.i. The total number M of sets of rollers if preferably at least K=4 and at most K=500. All rollers are driven via the center shaft 12.

FIG. 5 shows a conveying installation 52 with a plurality of omnidirectional wheel units 40.n that are arranged in a regular pattern—in a chessboard pattern in the present case—and form a matrix 54.

The conveying installation 52 includes an in-feeder 56, by means of which a package 58 to be sorted is conveyed on an upper side of the matrix 54. The package 58 is identified by means of a capturing device 60, for example a camera or an RFID reader, and assigned to one of several out-feeders 64.p (p=1, . . . . P; here: P=9) by a computing unit 62.

The computing unit 62 captures images from the camera 60 and uses them to calculate the position and orientation of the package 58. On this basis, the computing unit 62 determines which omnidirectional wheel units 40.i′ are below the package 58 and controls them in such a way that the package 58 is conveyed to the allocated out-feeder 64.p′. In the process, it is possible that the computing unit 63 controls the corresponding control units 46.i′ such that the package 58 is conveyed into a preset orientation, for example with its longitudinal axis in the direction of conveyance of the corresponding out-feeder 64.p′.

In the partial FIGS. 6a-6g, FIG. 6 illustrates a bearing drum 24 for a two-rowed omnidirectional wheel.

In the partial FIGS. 7a-7c, FIG. 7 depicts a first-set roller or second-set roller of an omnidirectional wheel 10 according to the invention, said roller having a first material area 66 and a second material area 68.

In the present case, in the first material area 66 the roller is made of a first plastic, such as polyoxymethylene, and in the second material area 68 it is made of a second plastic, which has a greater static friction coefficient in relation to cardboard as a friction partner than the plastic in the first material area 66, for example silicone, rubber and/or thermoplastic urethane.

FIG. 8a depicts, in a partially exploded view, an omnidirectional wheel 10 according to the invention in the form of an omnidirectional shaft 48, where each of the rollers is supported by means of a cage 70. The cage 70 surrounds the roller—in FIG. 8a, the roller 14.3—like a frame. The roller is rotatably mounted by means of a shaft 72. The shaft 72 can be accommodated in bearing bushes 74.1, 74.2, but this is not essential. The cage 70 forms a snap-on connection with the bearing drum 24. To this end, the cage 70 may have at least one snap-in hook 76. A bearing seat 78 of the shaft 72 is configured entirely on the cage 70.

The omnidirectional shaft 48 may have third-set rollers 80.i, which are constructed and arranged like the first-set rollers 14.i. An axial height H is depicted. It should be noted that the first-set rollers 14.i are arranged at the same axial height, the first-set height H₁₄. The second-set rollers 16.i are arranged at the second-set height H₁₆, which is different from the first-set height H₁₄.

With the aid of the cage 70, the rollers can be attached to the bearing drum 24 from the axial outside (as shown in FIG. 8a). A gap S between the roller and the cage is so small that objects to be conveyed are highly unlikely to be drawn into the gap.

FIG. 8b depicts the cage 70 in a perspective view.

In a partially exploded view, FIG. 9a depicts an omnidirectional wheel 10 according to the invention in the form of an omnidirectional shaft 48, where the rollers are supported by means of a frame 82. A first bearing seat part 78a is configured on the frame 82. A second bearing seat part 78b, on the other hand, is configured on the bearing drum 20. The bearing drum 24 could also be referred to as a bearing pipe or bearing shaft. The frame 82 is connected to the bearing drum 24 by means of a snap-on connection. To this end, the frame 82 may have a snap-in hook 76.

FIG. 9b depicts the frame 82 in a perspective view.

The cage 70 (FIG. 8b) and the frame 82 (FIG. 9b) can each comprise actuation holes 84, which are designed to insert a tool W, by means of which the snap-in hook 76 can be moved from its closed position into an open position. To do so, the tool W presses on the snap-in hook 76. In its closed position, the form-fit connection is between the cage 70 or frame 72 and the bearing drum 24.

FIG. 10a shows a roller according to one preferred embodiment. The tooth base G runs along a flat strip, which extends in a spiral on the lateral surface of a cylinder.

FIG. 10b depicts a roller 14.1 made up of three components, namely a center part 86 and two caps 88.1, 88.2. 88.1 and 88.2 are made of a material with a lower hardness than the material of the center part 86. This means that the caps 88.1, 88.2 are subject to greater wear, but grip is better in relation to the objects to be conveyed.

FIG. 10c shows the center part 86, which is a plastic injection-molded part. FIG. 10d depicts the cap 88.1, which is also a plastic injection-molded part and can be connected in a form-fitting manner to the center part 86.

The center part 86 is made, for example, of POM (polyoxymethylene). The caps 88.1, 88.2 are made of polyurethane, for example. The center part 86 may comprise multiple struts 90.j (e.g. j=1, 2, . . . 6) which engage in a form-fitting manner with the recesses 92.j in the caps.

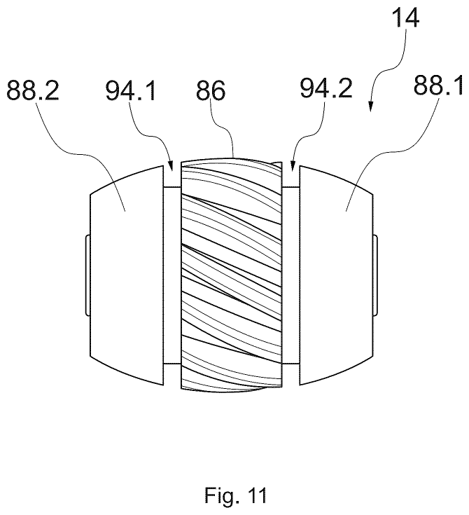

FIG. 11 depicts an alternative embodiment of a roller 14 for an omnidirectional wheel according to the invention, an omnidirectional shaft according to the invention and an omnidirectional matrix according to the invention. The caps 88.1, 88.2 are molded onto the center part 86. The caps are preferably molded onto the center part 86 in a single piece. To produce the roller 14, the center part 86 is first produced by plastic injection molding.

The caps 88.1, 88.2 are then molded onto the center part 86 in the same injection mold or a different injection mold, which is preferable but not essential. The center part 86 is axially so permeable to liquid that, during injection molding of the caps 88.1, 88.2, plastic can and does get from one side of roller 14 to the other side along the rotational axis: even without the other features of the embodiment described, this represents a preferred embodiment. In other words, the caps 88.1, 88.2 are directly (i.e. without an intermediate element) connected to each other as a single piece, i.e. without joints. It is favorable if the molding of the caps 88.1, 88.2 is done from one side of the center part 86, for example from the side of the cap 88.1. The material that forms the other cap, so the cap 88.2 in the example, flows through the center part 86.

Preferably, the open tooth gaps are sealed by means of slides when injection molding the caps 88.1, 88.2. These slides can each create a circumferential channel 94.1, 94.2.

Reference list

| | |
|---|---|
| 10 | omnidirectional wheel |
| 12 | center shaft |
| 14 | first-set rollers |
| 16 | second-set rollers |
| 18 | first-set roller outer thread |
| 20 | second-set roller outer thread |
| 22 | drive worm |
| 24 | bearing drum |
| 26 | first thread section |
| 28 | second thread section |
| 30 | depression |
| 32 | bearing web |
| 34a, 34b | bearing point |
| 36 | connecting web |
| 38a, 38b | depression |
| 40 | omnidirectional wheel unit |
| 42 | center shaft drive |
| 44 | bearing drum drive |
| 46 | control unit |
| 48 | omnidirectional shaft |
| 50 | set |
| 52 | conveying installation |
| 54 | matrix |
| 56 | in-feeder |
| 58 | package |
| 60 | capturing device |
| 62 | computing unit |
| 64 | out-feeder |
| 66 | first material area |
| 68 | second material area |
| 70 | cage |
| 72 | shaft |
| 74 | bearing bush |
| 76 | snap-in hook |
| 78 | bearing seat |
| 80 | third-set roller |
| 82 | frame |
| 84 | fastening hole |
| 86 | center part |
| 88 | cap |
| 90 | strut |
| 92 | recess |
| α | helix angle |
| φ | angular offset |
| γ | offset angle |
| A | roller rotational axis |
| A₁₂ | center shaft rotational axis |
| A_{14.i} | first-set roller rotational axis |
| E | reference plane |
| G | tooth base |
| K | outer contour |
| M | total number of sets of rollers |
| R_{G} | tooth base radius of curvature |
| R_{K} | outer contour radius of curvature |
| R_{L} | bearing drum radius of curvature |
| U | circumferential direction |
| \vec{ν} | speed |
| W | tool |

1. An omnidirectional wheel, comprising:
(a) a center shaft which extends along a center shaft rotational axis,
(b) a bearing drum which is rotatable about a bearing drum rotational axis,
(c) at least three first-set rollers which
(i) are mounted on the bearing drum such that they are rotatable about a first-set roller rotational axis which extends transversely to the center shaft rotational axis,
(ii) are arranged around the center shaft at an angular distance from each other, and
(iii) each have a helical-toothed first-set roller outer thread,
(d) at least three second-set rollers which
(i) are mounted on the bearing drum such that they are rotatable about a second-set roller rotational axis which extends transversely to the center shaft rotational axis,
(ii) are arranged around the center shaft at an angular distance from each other, and
(iii) each have a helical-toothed second-set roller outer thread,
(e) wherein each of the at least three first-set rollers and each of the at least three second-set rollers at least partially protrude above the bearing drum,
(f) wherein the omnidirectional wheel is configured such that a rotation of the center shaft about the center shaft rotational axis relative to the bearing drum (24) effects a rotational movement of the at least three first-set rollers and the at least three second-set rollers about their respective first-set roller rotational axis and second-set roller rotational axis in a same direction of rotation in each case, and
(g) wherein the center shaft comprises a drive worm that engages with the first-set roller outer thread and the second-set roller outer thread.

2. The omnidirectional wheel according to claim 1, wherein the at least three first-set rollers are arranged at a same distance to the center shaft and the at least three second-set rollers are arranged at a same distance to the center shaft.

3. The omnidirectional wheel according to claim 1 wherein
(a) the at least three first-set rollers and the at least three second-set rollers each have a barrel-shaped outer contour, at least in an area of the respective first-set roller outer thread and the second-set roller outer thread, and
(b) the first-set roller outer thread and the second-set roller outer thread is formed by depressions sunk into the outer contour, and
(c) the first-set outer thread and the second-set outer thread extends at most across half a height of the first-set rollers and second-set rollers, respectively.

4. The omnidirectional wheel according to claim 1 wherein a tooth base of the first-set roller outer thread and the second-set roller outer thread is concavely curved and/or a helix angle of the first-set roller outer thread and the second-set roller outer thread is between 3° and 65°.

5. The omnidirectional wheel according to claim 1 wherein a
tooth base of the first-set roller outer thread and the second-set roller outer thread is more curved than an outer contour of one of the at least three first-set rollers in an the area of the first-set roller outer thread in relation to a direction of a corresponding rotational axis of the omnidirectional wheel.

6. The omnidirectional wheel according to claim 1 wherein
(a) a tooth base of the first-set roller outer thread and the second-set roller outer thread has a tooth base radius of curvature,
(b) the drive worm has a drive worm outer radius, and
(c) a quotient of the tooth base radius of curvature as numerator and the drive worm outer radius as denominator is between 2 and 0.5.

7. The omnidirectional wheel according to claim 1 further comprising at least a third set of rollers which
(i) are mounted on the bearing drum such that they are rotatable about a rotational axis which extends transversely to the center shaft rotational axis,
(ii) are arranged around the center shaft at an angular distance from each other, and
(iii) each have an outer thread and engage with the drive worm.

8. The omnidirectional wheel according to claim 1 further comprising:
(a) a bearing drum drive for driving the bearing drum about the center shaft rotational axis,
(b) a center shaft drive for driving the center shaft, and
(c) a control unit configured to automatically control the bearing drum drive and the center shaft drive.

9. The omnidirectional wheel according to claim 1 wherein
(a) the bearing drum comprises one bearing web for each first-set roller of the at least three first-set rollers,
(b) each bearing web has two bearing points for one roller each of the at least three first-set rollers,
(c) the bearing webs are each connected to two connecting webs in a circumferential direction, and
(d) and the connecting webs each have a radial depression between two bearing points in the circumferential direction.

10. The omnidirectional wheel according to claim 1 wherein
at least one roller of either or both the at least three first-set rollers and the at least three second-set rollers
(a) has a first material area in which the first-set roller outer thread or the second-set roller outer thread is configured, and
(b) a second material area, which differs from the first material area in terms of one or more of hardness, and static friction coefficient against cardboard and/or acrylonitrile butadiene styrene.

11. The omnidirectional wheel according to claim 1 wherein
(a) at least a majority of rollers of the at least three first-set rollers and the at least three second-set rollers are mounted on the bearing drum by a cage,
(b) wherein the cage is connected to the bearing drum via a snap-on connection in a reversible manner.

12. The omnidirectional wheel according to claim 11, wherein the cage
(a) is made of plastic, and
(b) comprises a bearing bush for supporting the respective roller.

13. The omnidirectional wheel according to claim 1 further comprising a shaft, wherein at least one rollwe of the at least three first-set roller and the at least three second-set rollers are mounted on the shaft, wherein the at least one roller is rotatable relative to the shaft.

14. The omnidirectional wheel according to claim 1 wherein
(a) at least a majority of the rollers of the at least three first-set rollers and the at least three second-set rollers are mounted on the bearing drum by a frame,
(b) in combination with the bearing drum, the frame forms a bearing seat for the at least a majority of the rollers, and
(c) wherein the frame is connected to the bearing drum via a snap-on connection in a reversible manner.

15. The omnidirectional wheel according to claim 14 wherein
a slot between a roller of the at least a majority of rollers and the frame is at most 1 mm.

16. The omnidirectional wheel according to claim 1 wherein
at least for a majority of the rollers of the at least three first-set rollers and the at least three second-set rollers, a tooth base of the at least a majority of rollers extends along a strip that extends in a spiral on the lateral surface of a cylinder.

17. An omnidirectional shaft, comprising:
(a) a center shaft which extends along a center shaft rotational axis, and
(b) a bearing drum that is rotatable about a bearing drum rotational axis,
(c) at least three first-set rollers which
(i) are mounted on the bearing drum such that they are rotatable about a first-set roller rotational axis, which extends transversely to the center shaft rotational axis,
(ii) are arranged at a same distance and at an angular distance from each other around the center shaft, and
(iii) each have a helical-toothed first-set roller outer thread,
(d) at least three second-set rollers which
(i) are mounted on the bearing drum such that they are rotatable about a second-set roller rotational axis which extends transversely to the center shaft rotational axis,
(ii) are arranged at a same distance and at an angular distance from each other and at a respective angular offset □ to a respective first-set roller of the at least three first-set rollers around the center shaft, and
(iii) each have a helical-toothed second-set roller outer thread,
(e) wherein each of the at least three first-set rollers and each of the at least three second-set rollers at least partially protrude above the bearing drum,
(f) wherein the omnidirectional shaft is configured such that a rotation of the center shaft about the center shaft rotational axis relative to the bearing drum effects a rotational movement of the at least three first-set rollers and the at least three second-set rollers about their respective first-set roller rotational axis and second-set roller rotational axis in a same direction of rotation in each case,
(g) wherein the center shaft comprises a drive worm that engages with the first-set roller outer thread and the second-set roller outer thread, and
(h) at least a third set of rollers which
are mounted on the bearing drum such that they are rotatable about a rotational axis which extends transversely to the center shaft rotational axis,
are arranged around the center shaft at an angular distance from each other, and
each have an outer thread and engage with the drive worm.

18. A conveying installation, comprising
(a) a plurality of omnidirectional wheels according to claim 1 that are arranged along a conveying plane, and
(b) a control unit configured to automatically carry out a method comprising
(i) detecting a target conveying speed for at least one omnidirectional wheel of the plurality of omnidirectional wheels, and
(ii) controlling a bearing drum drive and a center shaft drive of said at least one omnidirectional wheel so that a contact point speed of the points of the at least one omnidirectional wheel which protrudes furthest above the conveying plane corresponds to the target conveying speed.

19. The omnidirectional wheel of claim 1 wherein each of the three second set rollers have an angular offset to a corresponding one of the three first set rollers.

20. The omnidirectional wheel of claim 11 wherein a slot between a roller of the at least a majority of rollers and the cage is at most 1 mm.
